(19) United States
(12) Patent Application Publication
(10) Pub. No.: US 2012/0161485 A1
(43) Pub. Date: Jun. 28, 2012

(54) Pendulum level ride universal seat

(76) Inventor: Alvin Stockwell, Kingsville (CA)

(21) Appl. No.: 12/930,095

(22) Filed: Dec. 28, 2010

(51) Int. Cl. B60N 2/39; B60N 2/24; B60N 2/04; B60N 2/10; B60N 2/005; B60N 2/02

(52) U.S. Cl. 297/344.11

(57) ABSTRACT

1. The prime object of the P.L.R.U. seat is to allow the seat to remain level and the operator upright, when traversing a side hill, slope or valley.

2. A problem exists with prior art seats available today, as the seat tips sideways with the vehicle, making it difficult to remain on the seat without hanging on to the fender or bracing with the feet.

3. By using a self locking sleeve bearing to hang the seat in a pendulum fashion, allows the seat to remain level, and thereby a more comfortable and safe condition, with hands and feet free to operate the controls.

4. Incorporating a lift and lowering device allows mounting the seat on a wide variety of both new and old vehicles. No other prior art seat has taken this universal approach for replacement seats.

### PRIOR ART

Comparing prior art seating, I could not find a truly universal seat. The word universal seemed to apply only to a bolt pattern in the floor plate, making them adaptable to different brands of tractors, but only if the mounting configuration is similar. These prior art replacement seats have no height adjustment, leaving them with a very limited adaptability.

To give you an example, if I installed this prior art, so called “universal” seat on my lawn mower or my Ferguson and International tractors, the seat portion would be higher than the steering wheel.

Installation of the P.L.R.U. seat with height adjustment solves the height problem, with a few turns of the crank on the jack. Plus, the benefits of the pendulum level ride seat can be realized on many new and old vehicles by utilizing the universal mounting.

Performing a patent search regarding a level ride pendulum universal seat, I found no relevant passages or figures for any prior art seats that referred to a level ride on a hillside slope, or that were completely universal.

The words “inverted pendulum” was used in three of the patents I thought might be similar, US Patent Nos 20100305840, 20100280745, and 20100114420, but upon comparison, none of them were relevant to my invention.

### REFERENCE NUMBERS

I have enclosed nine sheets of drawings, along with a chart of reference numbers to describe the components and their assembly. Preceding some numbers are the letters “PA” which stands for Prior Art, e.g.: PA1 is the seat cushion, PA2 is the backrest. These two items are obvious, as something similar can be found on most tractor seats, and are sold widely on the after-market.

After much consideration concerning height adjustment, I purchased a top winding, square tube weld-on jack, with a leg extension and floor plate, (prior art from a different field). I numbered it PA4. In order to explain the modifying to PA4, I also added some PA numbers to the components involved as well as regular numbering for parts added.

Note: All right and left (R/L) number designations have been used with a rear view only; some numbering may be confusing when observing a component from the front side.
PA1 Seat cushion
PA2 Back rest
PA3 Extension leg+foot plate
PA4 Square tube jack
PA5 Jack screw
PA6 Jack inner sleeve
PA7 Base plate (formerly foot plate)
PA8 Folding crank handle
9R/L Floor rails—tapered angle iron
10 Floor plate with bolt pattern . . . 10 A+B Weld on Bolt Clips
11 Compression spring—stiff
12 Compression spring—medium
13 Square washer with oversize hole
14R/L Pivot bolts
15R/L Pivot plates—6 holes
16R/L Pivot anchor plates—2 holes welded to 9R/L
17R/L Pivot bolt holes
18 Mounting plate—welded to PA4
19 4 wedge braces—welded
20 Back plate for bearing Collar 22 with holes matching plate 18
22 Bearing collar—welded to 20
23 Lock pin lever assembly
24 Bearing sleeve welded to plate 24A
24A Mounting plate+matching holes in 26B
25 Retainer bolt+bearing shaft combined
25A Self-locking retainer nut
26S Seat support on pendulum horizontal portion
26B Pendulum backrest support—vertical portion. 26S+26B is 1 piece
27 steel plate bent 90°
28 Gear tooth slots and adjoining rotation slot
30 R/L Support roll plate welded each side to 35
30R/L Roller balls supporting 28
31 Adjustable roller ball platform
32R/L Adjusting bolts for roller ball platform
35 Plate strengthening flanges both sides of 26S/B
36 2 grease fittings
37 Shaft 25 bearing collar
38 Shaft 25 bronze bearing
38A Bearing collar set-screw on side of 37
W1 Inside only weld re: 24 to 24A
W2 Outside only weld re: 22 to 20
BU40 Base unit Assembly
SB50 Sleeve bearing assembly
AMP Alternate mounting post
MP Mounting plate

### DRAWINGS

FIG. 1 Bottom Perspective view of base unit BU40—dwg page 1:9

The bolt pattern floor plate 10 is shown flush with the bottom edge of floor rails 9R/L.

The mounting leg PA3, attached to base plate PA7, along with pivot plates 15R/L, welded at each end of PA7, is in position between the rails 9R/L, with pivot anchor plates 16R/L, welded to top edge of rails 9R/L and pivot holes 17R/L lined up to receive pivot bolts 14. This allows leg PA3 to be placed in a tilted or vertical position, with a small bolt in the lined-up adjusting holes in plates 15 & 16 on each side, to secure the post PA3.

FIG. 1A

Right-side view, inset, should help to explain the above. The left side not shown is an exact repeat. The following drawing, FIG. 2, should complete the demonstration of BU40.

FIG. 2 Perspective Top view of BU40—dwg page 2:9

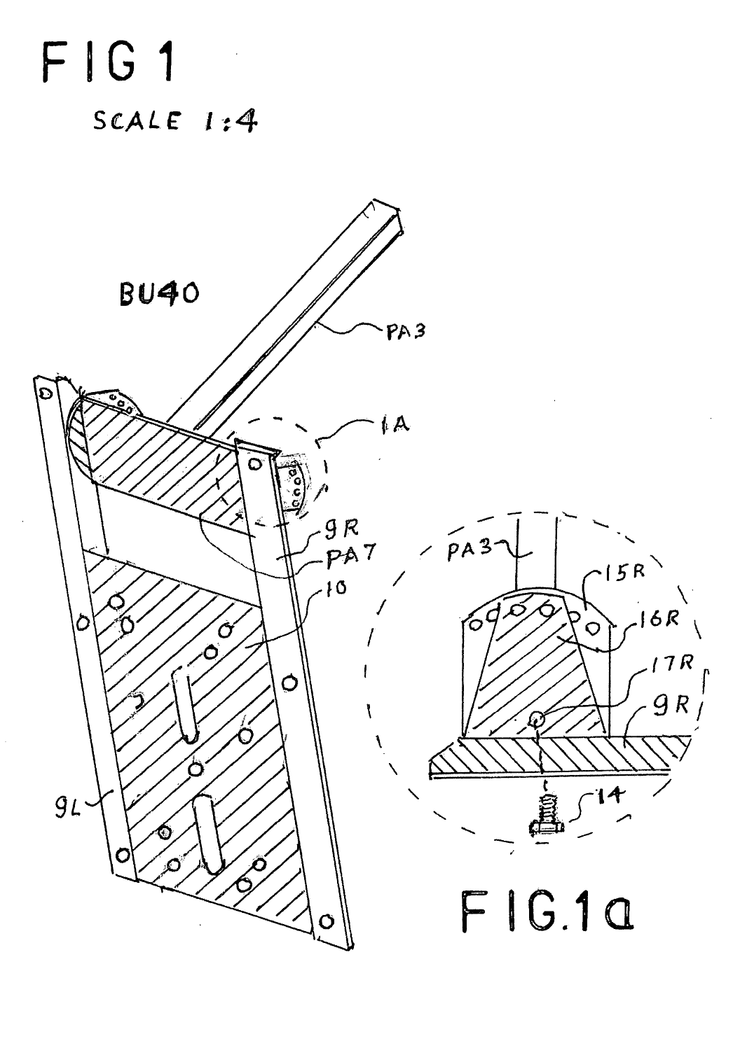

The vertical flanges on the angle iron floor rails 9R/L are tapered to the front to decrease any tripping danger, compared to a full-flanged angle iron. Tapering also allows a flat space at the end of the rails to allow the front weld clips 10A on plate 10 to utilize the ready-made bolt holes in 9R/L.

By adding holes to 9R/L, the vertical weld clips 10B at the rear of plate 10 can be secured to the inside of 9R/L. A different configuration of the bolt holes in plate 10 might prove to be more acceptable when attaching same to different vehicles.

Bolting plate 10, instead of welding, allows easy removal of 10. Opening the space between rails 9R/L allows a necessary access area, when adapting the level ride system to riding mowers. With batteries or gas tanks directly under the seat and between the rails 9R/L, with 10 removed, the rails 9R/L only, are used to bolt the unit down, adding to the versatility of level ride to adapt to more vehicles. This option was not found available on prior art.

Due to the tearing pressure tilting forward on the weld securing PA3 to the base plate PA7 (created by offset operator's weight) four wedge braces No 19 have been added to strengthen this area.

The dot-dot-dash line demonstrates the assembling of PA4 over the leg PA3. I found that spring 11 was not a snug fit into sleeve PA6. Enlarging the top ring on 11 to a larger diameter on one ring, was enough to keep the spring from falling out when lifting the seat and jack PA4 off of PA3, allowing a switch of the seat to another vehicle with a pre-installed second extension leg, similar to PA3.

Tack welding was the easy way to hold washer 13 in place, allowing the sliding of PA6 down over the washer 13 and leg PA3, until the jack PA4 is supported on spring 11, thereby softening the ride and shock on rough terrain. (continued)

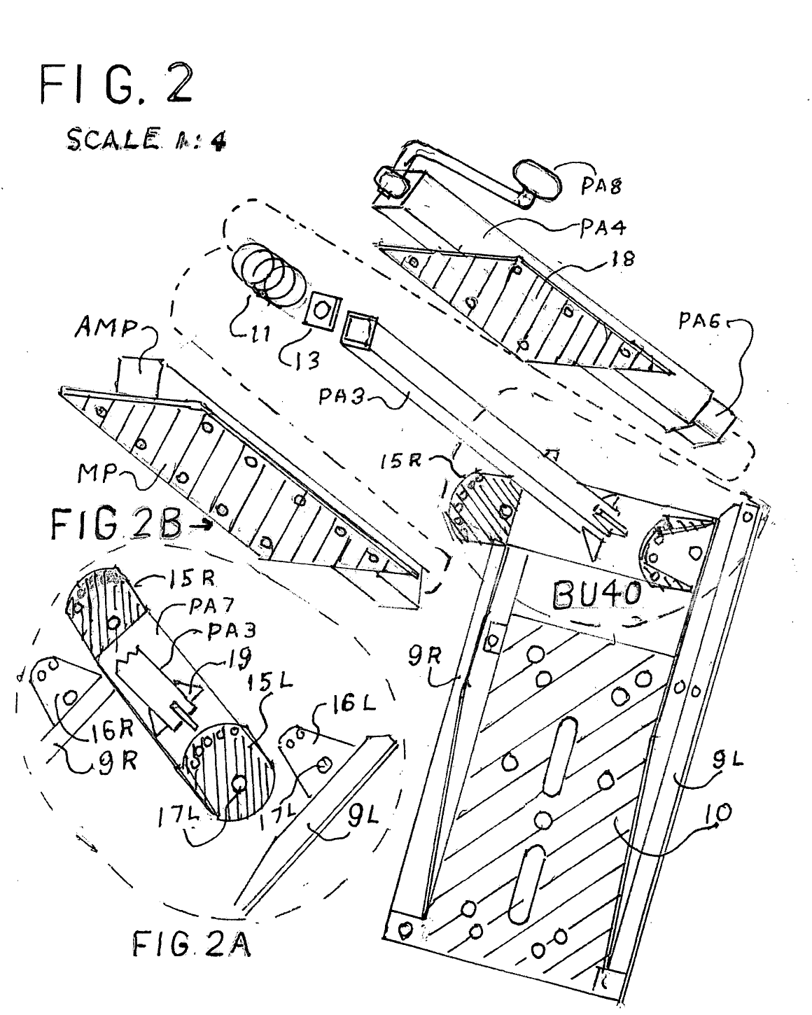

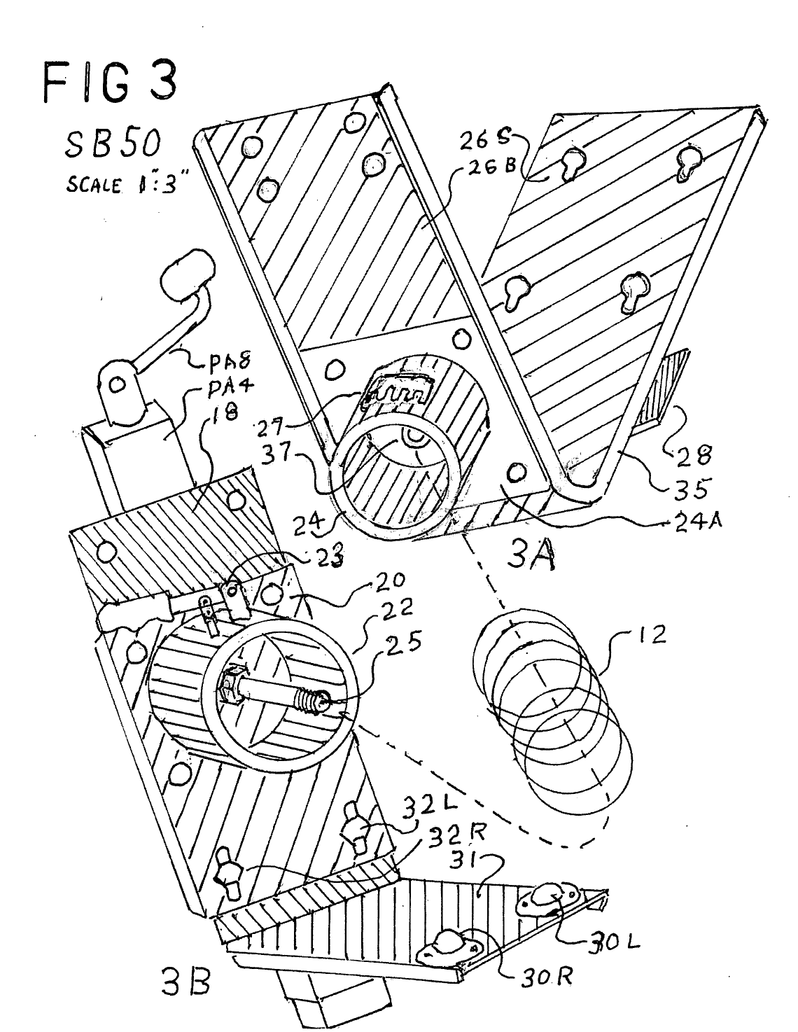

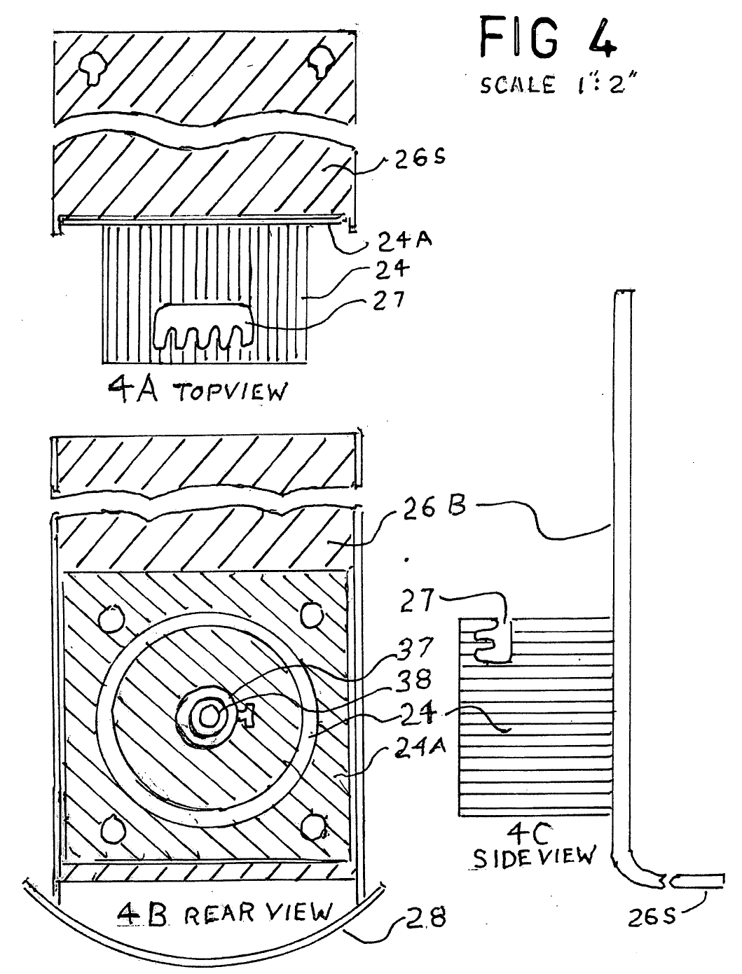

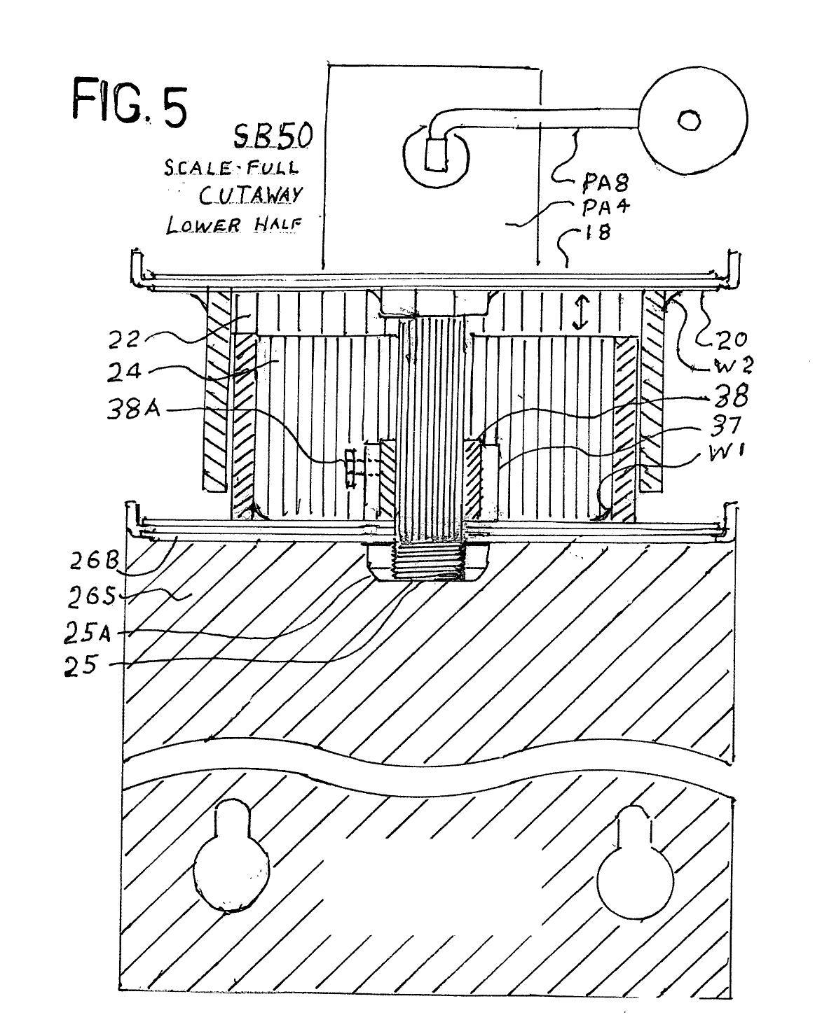

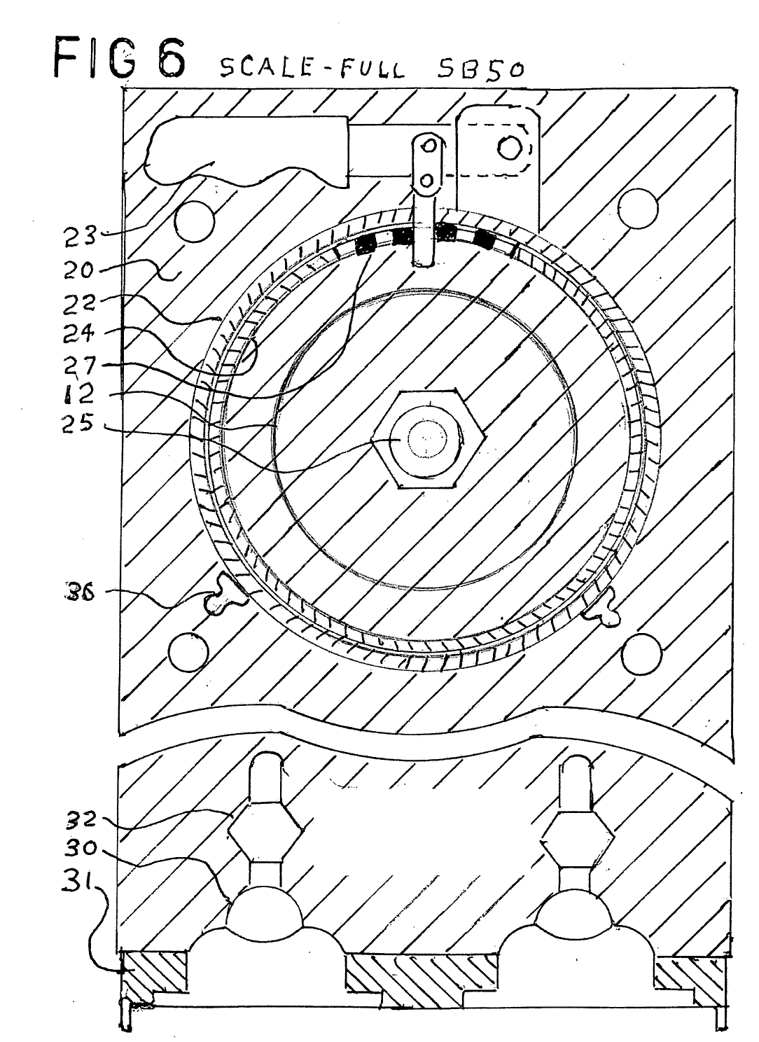

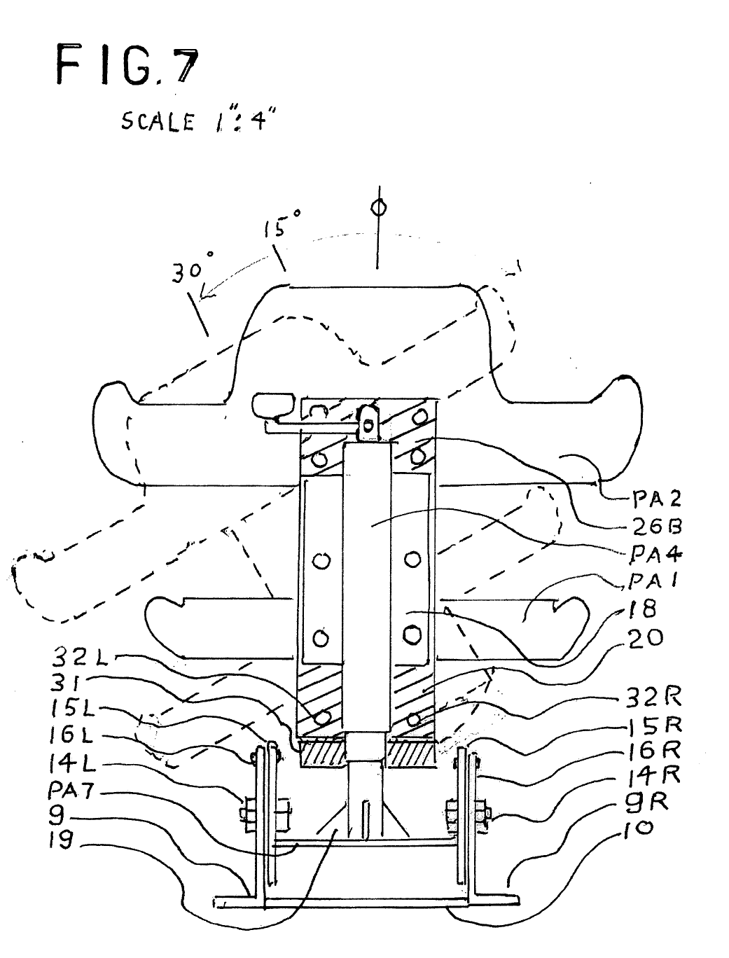

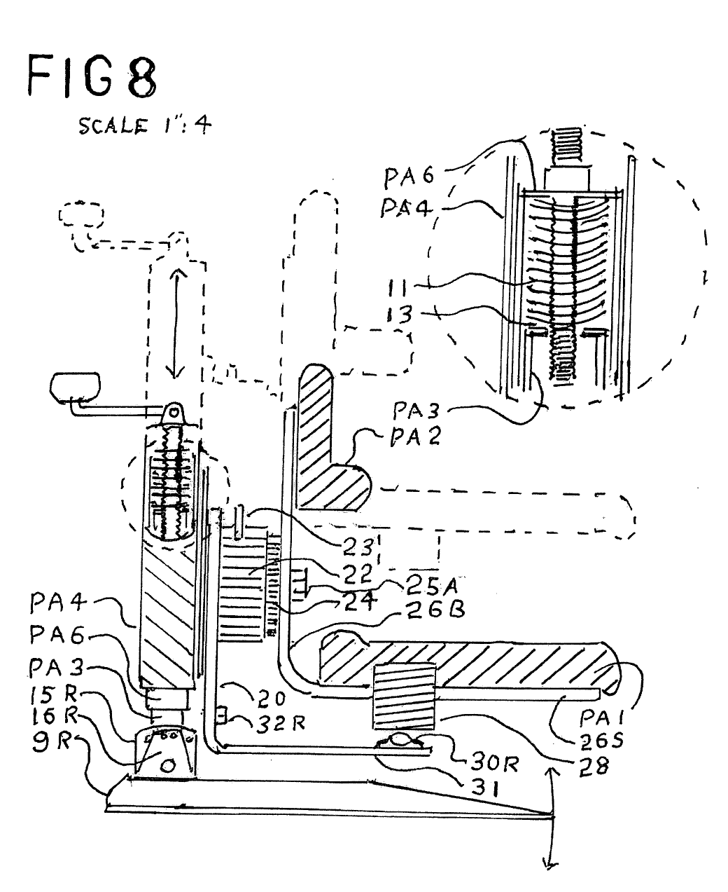

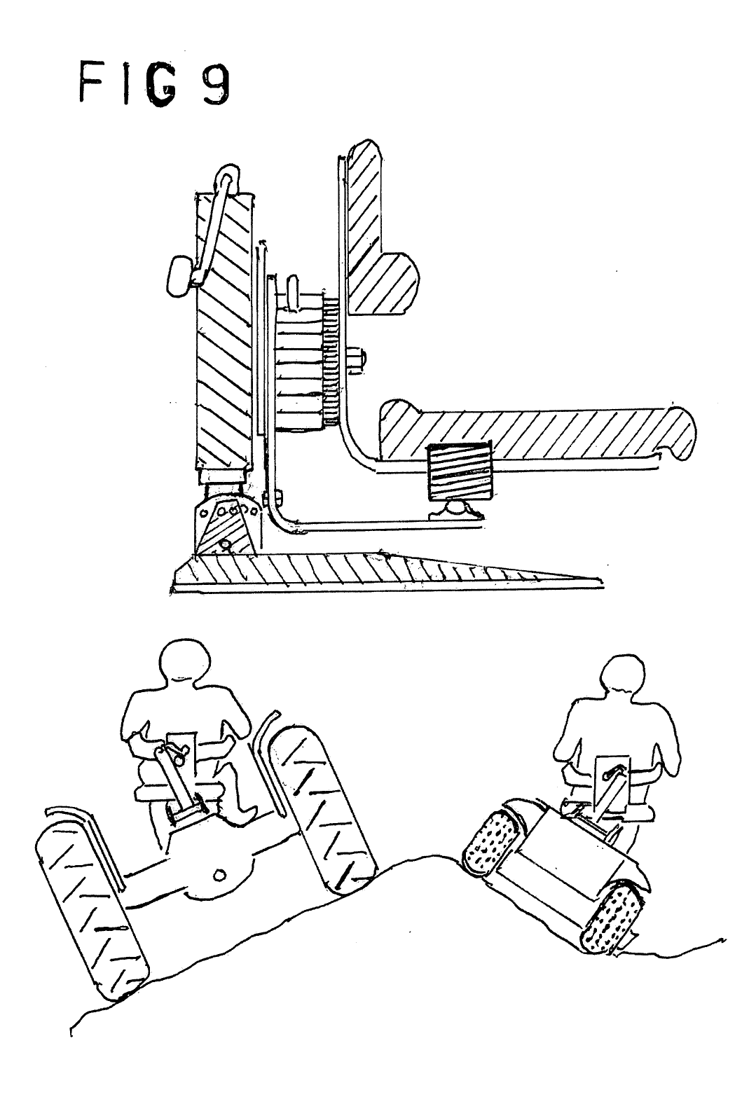

FIG. 2A may help to explain the pivoting components; this pivot action is necessary, especially when the floor rails 9R/L have to be attached to a vehicle having a declined or inclined mounting area, to still allow the seat unit to be tilted backward or forward to a comfortable position.

FIG. 2B an alternate mounting plate (M.P.+Post Amp.) can be used when a preset height only, is adequate. The adjustable screw jack PA4 can be eliminated, using a single square tube, same size as PA6, with a welded top plate. The support carrier spring in #11 can still be utilized when the square tube replacing Jack PA4 is installed over Leg PA3.

By extending the overall length of plate 18 (welded to the new square tube and adding multiple mounting holes every 2 inches to match plate 20) the seat can be installed to the preferred height and attached more permanently.

Using this alternate mount would lower the cost of manufacturing and still retain height adjustment, necessary to retain the universal aspect of multiple applications. This would not change the overall concept. Other than, to change the height, which would be a much slower process.

FIG. 3 Perspective view of bearing sleeve SB50—dwg page 3:9

This view consists of two drawings and the integration of 3A and 3B to form the sleeve bearing SB50 and the components to make this invention operational.

Moving forward from FIG. 2 drawings, starting with the jack PA4, the mounting plate 18 is welded to pA4 in a centered position on the exterior of the jack, plate 18 is showing 2 extra mounting bolt holes at the top. Although the jack PA4 has a range of 10 to 12 inches, if the height is not sufficient, the top holes can be utilized to increase the range another 4 inches, by moving plate 20 to the upper holes in 18.

By extending the collar bearing plate 20 and cutting bolt slots for adjusting bolts 32R/L at the bottom, this plate 20 is also supporting and providing adjustment up & down for platform 31 supporting the roller balls 30R/L.

The dot-dash line is showing the assembly of SB50. The spring 12 is necessary to push sleeve 24 out to a locking position for lock pin 23 to engage the gear teeth 27.

FIG. 4 Three views of Sleeve Bearing 24—dwg page 4:9

Top view 4A

This demonstrates the sleeve bearing 24, with the gear tooth slots 27 and the slotted space for rotation when pin 23 (not shown) is disengaged, to allow in-and-out motion when operator pushes on back rest PA2

Front view 4B

Drawing 4B demonstrates sleeve 24 is centered and welded W1 to a back plate 24A. It is absolutely necessary to weld 24 to 24A, on the inside only, of the sleeve, as indicated by W1. Also welded to 24A is bearing collar 37, which contains the set screw 38A, to secure the oil light sleeve bearing 38.

The backer plate 24A is bolted to the upright portion of pendulum 26B, with the sleeve 24, center point, at a radius measuring 5 inches or 125 mm, directly above the roll plate 28, which has been precision rolled to the same radius and welded at each side to flanges 35. The pendulum platform 26S for seat PA1 is not shown completely, due to lack of space. 26S is, however, shown in FIG. 3 drawing, with roll plate 28 positioned under the weight of the operator, thereby reducing the strain on the pendulum bearing SB50

Side View 4C

Showing the vertical or seat back support of pendulum plate 26B, with 35 indicating the 90°-0.5 inch or 12 mm flanges, extending the full length, on each side of 26B and 26S to strengthen same. Consisting of one piece of steel bent 90° to form the pendulum. 26B is the back or vertical portion.

The seat support plate 26S forms the horizontal portion of the pendulum. 26S is not shown due to lack of space.

FIG. 5 Top view sleeve bearing SB50—dwg page 5:9

This view demonstrates a horizontal cut-away for sleeve bearing SB50, showing the lower half of the unit, located between the mounting plate 18 and the pendulum back rest plate 26B.

The cutaway reveals the space provided for the sleeve 24 to slide deeper into the bearing collar 22, when the unit is compressed to allow the unlocking action to take place. The threaded bolt 25 welded to back plate 20 forms the major support of the pendulum 26B and 26S. The sleeve bearing 38 surrounding the front portion of 25 allows rotation, and the in-and-out action. The self-locking retainer nut 25A adjusts to hold the proper position as spring 12 (not shown) pushes sleeve 24 forward to a locked position. Spring 12 seen in FIG. 3 shows positioning of same.

FIG. 6 Sleeve bearing unit SB50—Front view—dwg page 6:9

Drawing 6A demonstrates a vertical cutaway of sleeve bearing unit SB50, consisting of the back half of the outer bearing collar 22, the inner sleeve 24, and revealing the gear tooth notches 27, with lever pin 23 engaged in the center notch 27.

The lower half of collar 22 contains two grease fittings 36, which are necessary to reduce friction, especially in the lower half that carries the weight. Platform 31 carries the weight on two multi-directional roller balls 30R/L, mounted on an adjustable platform 31, that extends forward, under the roller plate 28 (not shown), plus two up-and-down adjusting slots and bolts 32R/L. These bolts are used to hold the roller balls 30R/L up, tight under plate 28. To carry the weight of the operator, roller balls 30R/L provide a friction-free movement of the seat, back and forth, side to side.

The pendulum center shaft 25 and bolt head is shown welded to plate 20. Lifting, lever assembly 23 disengages the locking pin, allowing the inside sleeve 24 to rotate freely inside sleeve 22. Lowering lever pin 23 allows the operator to push back, thereby moving gear teeth 27 away from pin 23, allowing the seat to find a more comfortable position as the pin 23 is now in the rotating slot of 27. The spring 12 (not shown) forces the gear teeth 27 to engage the lock pin 23 when the backward push is relaxed by the operator.

FIG. 7 Rear view P.L.R.U. seat—dwg page 7:9

This view demonstrates the P.L.R.U. seat with mounting base unit BU40 supporting the leg PA3 welded and braced 19 to base plate PA7; providing a forward and back tilting action, via pivot bolts 14R/L and pivot plates 15R/L, pivot anchor plates 16R/L, with two small bolt holes at the top edge, lined up with one of the holes along the top edge of pivot plates 15R/L.

Inserting a bolt on each side secures the post PA3 in a stationary position.

The dotted outline of the backrest PA2 and seat PA1 is demonstrating the rotation position of same, as it related to the pendulum support system.

In actual operation, the base unit BU40, bolted to a tractor, would be the portion tilted to one side, and the pendulum seat PA1 could remain level, regardless of the slope the tractor was on, explaining the object of my invention.

FIG. 8 Right side view P.L.R.U. seat—dwg page 8:9

The dotted outlines demonstrate the height adjustment possible by turning the folding crank PA8. The floor rails 9R/L are also adjustable for mounting purposes on different vehicles.

A cutaway of jack PA4 shows the modification to soften the ride and absorb the shock possible on rough terrain. This modification I felt was very necessary, and quite simple to accomplish, using a square shaped washer 13 the same size as the top of post PA7, tack welded on top of the post PA7, and having a large hole in the center to accommodate the jack screw PA5, and support a stiff compression spring 11.

No drawing was made of the left-side view, as it would be a duplicate of FIG. 8.

FIG. 9 Tractor and Mower Demonstration—dwg page 9:9

A right-side view of the P.L.R.U. seat showing a tractor and mower travelling on sloping land at approximately 28°. Both operators using level ride seating with no straining to remain upright and in control.

Mission accomplished.

There are possibly other methods or assemblies or conversions of prior art, to create a similar seat support and level action. However, I believe I exhausted at least three of them with my experimenting on this idea over the past 21 months.

My first attempt as a single hinge under the seat, allowing the seat to tip sideways. This turned out to be completely unstable and uncontrollable, even with two mini hydraulic shock absorbers crisscrossed under the seat. My locking system as well, would not stand the strain, and was difficult to unlock or lock the seat in any position.

My second designed was completely changed when a pendulum idea came to me. I purchased a flange-type roller bearing to hang my pendulum-like seat support. A roller bearing worked, but was too expensive compared to the use I would get (it only had to turn 30° in either direction).

However, I finished the seat support to the point of testing my pendulum theory, and it worked, but I was already thinking about a simple sleeve-type bearing and a better and stronger seat platform.

I purchased an aftermarket import tractor seat with a double spring, hydraulic shock absorber built into the support frame, similar to some original equipment seats being used on some tractor models.

I then installed a sleeve bearing made from a 0.75 inch pipe nipple and a 0.75 inch bolt. Using the seat and backrest support plate, I raised the seat slightly, to install a roll plate under the seat, supported by two nylon rollers. I drilled a series of holes in the roll plate for a lever-operated locking system, to stabilize or lock the seat when the self-levelling action wasn't needed.

The conversion worked very well, and it was apparent that the pendulum sleeve bearing would also work on prior art seats with some modifications. However, what I was trying to accomplish was close to impossible with any prior art seat that I could find, as no height adjustment was available.

The only versatility I could find was a bolt hole pattern on the base or floor plate to allow these seats to be installed on the cab floor of certain tractor models.

Without a height adjustment, it was not possible to install that seat on my lawnmower or Ferguson and International tractors, unless I wanted to sit as high as the steering wheel.

I went back to my second model, with a jack to lift and lower the seat, and a few refinements, including two multi-directional roller balls and a removable floor plate. I felt with this built-in versatility, I now have a universal seat.

I knew my pendulum idea would work with a sleeve-type bearing; however I wasn't completely satisfied with a lever operated system to hold the seat in place. Experimenting a little more, I settled on a single unit, using a large enough sleeve bearing to combine a locking system inside the sleeve bearing. The unit I produced was beyond my hopes.

Making use of two short pieces of black pipe, one piece 3.50 inches (89 mm) inside dimension by 2 inches (50 mm) long, and one piece 4 inches (102 mm) inside dimension by 2 inches (50 mm). The 3.50 inch black pipe has an outside dimension of 4 inches, allowing it to slide inside the 4 inch inside dimension pipe forming the sleeve bearing SB50.

FIGS. 3, 4, and 5, drawn to scale, describe the assembly of SB50.

All drawings 1 through 8, drawn to scale, should assist anyone attempting to duplicate this pendulum level ride seat.

The promo model was assembled using mild steel. Actual manufacturing of this seat support system could involve other metals, one of which is diet steel, which is lighter and stronger. Forming and stamping would be standard practice as well. Stainless steel or aluminum is also an option that would improve appearance and strength, and possibly required if built for marine use.

Precision methods available today would create a higher quality, smoother-operating product, plus decrease assembly time on a production basis.

This unit SB50 with its quick unlock and relock system was like going from manual to automatic. Even though it is still manual, no hands or feet are required for an on-the-go quick change. No hydraulics or electric power is required.

I have combined a very versatile seat support system, with what I like to call a unique, self-levelling seat. I feel justified in my application for a patent of the Pendulum Level Ride Universal Seat. I have a US patent pending No 8982. In reference to my patent pending, drawing page 3 of 9, item 28, I moved the support roll plate 28 ahead to a stronger position under the seat, extending plate 31 repositioned, the roller balls 37R/L under roll plate 28

I eliminated the two retainer bolts 25R/L and the slots into which they fit on sleeve 24. The large bolt shaft 25 now operates as the retainer, keeping the sleeve 24 in place and still able to move in and out and rotate on the shaft. Shaft 25 also added considerable strength to unit SB50.

I felt these changes were necessary, and on the plus side, there was no change in the entire concept or action of this versatile level ride seat.

1. Using the P.L.R.U. seat, the operator can always be sitting upright, with their spinal column straight, this alone will eliminate a lot of back pain.

2. Providing more comfort and less fatigue, leads to longer work hours.

3. Provides a safer work environment, with less strain, not having to brace with your feet, or hang on with your hands to remain on the seat.

4. Having hands and feet free to control the equipment, there is no loss of job concentration from trying to hang on.

5. Changing the seating to a level and more comfortable position is easily accomplished, whether on level or sloping terrain.

6. Switching this P.L.R.U. seat from one vehicle to another is accomplished with an extra mounting post, preinstalled to accept the jack sleeve. By lifting the seat with the jack attached and sliding the jack sleeve on to the new post, your second vehicle is ready for the hills and valleys.

7. No hydraulic or electric power is required, another advantage using the pendulum system.

8. Using the P.L.R.U. seat could also encourage more contour farming, expand the use of marginal land, saving our soil where run off is a problem. Not to mention neater looking road sides from easier shallow ditch clean up.
